(19) United States
(12) Patent Application Publication
(10) Pub. No.: US 2006/0200284 A1
(43) Pub. Date: Sep. 7, 2006

(54) SYSTEM AND METHOD FOR PROVIDING VEHICLE CHECK INFORMATION USING NAVIGATION SYSTEM

(76) Inventor: JUNG HYUN HWANG, Icheon-shi Kyungki-do (KR)

Correspondence Address: IPLA P.A., 3580 WILSHIRE BLVD., 17TH FLOOR, LOS ANGELES, CA, 90010, US

(21) Appl. No.: 11/307,574

(22) Filed: Feb. 13, 2006

(30) Foreign Application Priority Data
Mar. 7, 2005 (KR) 10-2005-0018574

(51) Int. Cl. G06F 19/00

(52) U.S. Cl. 701/29; 701/200; 340/438

(57) ABSTRACT

A system and method for providing vehicle check information using a navigation system is provided. The system includes: a vehicle control system for receiving a predetermined signal, measuring a vehicle state, and outputting information on the measured vehicle state; and a navigation system for, in a navigation mode, generating and outputting a vehicle state measurement signal to the vehicle control system, receiving and displaying the vehicle state information in response to the vehicle state measurement signal, and, when the vehicle state is abnormal, searching map data for a vehicle check center for checking vehicle abnormality, and guiding to the searched vehicle check center.

### BACKGROUND OF THE INVENTION

1. Field of the Invention

The present invention relates to a navigation system, and more particularly, to a system and method for providing vehicle check information using a navigation system, in which a current vehicle state is measured and the measured vehicle state is combined with geographical information, thereby providing check information on the vehicle state and guiding to a corresponding peripheral facility.

2. Description of the Related Art

In general, a conventional car includes a display device equipped with a gauge board and informing a driver of an amount of fuel, a replacement of oil, and a replacement of battery, in order to inform the driver of a vehicle state, that is, an oil filling time, an oil replacement time, a battery replacement time, and a tire air pressure. However, in the conventional car, it is substantially difficult to grasp the oil and battery replacement times through the display device, and information on the oil and battery replacement times can be confirmed only through driver's careful management or regular check.

Further, there is a drawback in that the driver cannot easily find a service center or a gas station, thereby getting to be in a difficult situation in case where he/she urgently needs the service center or the gas station due to vehicle abnormality that is found while he/she drives the car after missing a vehicle check time.

As described above, there is a drawback in that the driver is difficult to grasp the vehicle check time using only the conventional display device provided for the gauge board, and when the vehicle is in an abnormal state, he/she cannot easily find the service center or the gas station, thereby getting to be in the difficult situation.

### SUMMARY OF THE INVENTION

Accordingly, the present invention is directed to a system and method for providing vehicle check information using a navigation system that substantially overcomes one or more of the limitations and disadvantages of the conventional art.

One object of the present invention is to provide a system and method for providing vehicle check information using a navigation system, for measuring a vehicle state, and guiding to a peripheral vehicle service center or gas station, depending on the measured vehicle state, using geographical information of the navigation system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a system for providing vehicle check information using a navigation system, the system including: a vehicle control system for receiving a predetermined signal, measuring a vehicle state, and outputting information on the measured vehicle state; and a navigation system for, in a navigation mode, generating and outputting a vehicle state measurement signal to the vehicle control system, receiving and displaying the vehicle state information in response to the vehicle state measurement signal, and, when the vehicle state is abnormal, searching map data for a vehicle check center for checking vehicle abnormality, and guiding to the searched vehicle check center.

In another aspect of the present invention, there is provided a method for providing vehicle check information using a navigation system, in a vehicle check information providing system having a vehicle control system controlling a vehicle electronic equipment, and a navigation system, the method including the steps of: in the navigation system, outputting a vehicle state measurement signal; in the vehicle control system, receiving the vehicle state measurement signal, and measuring a vehicle state; and in the navigation system, receiving and displaying information on the vehicle state in response to the vehicle state measurement signal, searching map data for a vehicle checking center capable of checking vehicle abnormality when the vehicle state is abnormal, and again searching for a path having the searched vehicle checking center as a via point, and performing a path guidance.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of a system for providing vehicle check information using a navigation system according to the present invention; and

FIG. 2 is a flowchart illustrating a method for providing vehicle check information using a navigation system according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

The present invention measures a vehicle state, that is, fuel, oil, a battery, and a tire air pressure, informs a driver of a gas station most proper to a current vehicle position using geographical information (or map data) of a navigation system when the fuel is short, and informs the driver of a service center when the oil, the battery, and the tire air pressure are lowered than a reference set value. Hereinafter, a broad term including the gas station and the service center capable of checking and solving an abnormal state of a vehicle is called “vehicle check center”. In order to allow driver's recognition, a name or building icon corresponding to the gas station or the service center of the geographical information is displayed on a display device of a navigation system.

Hereinafter, a description will be made with reference to the drawings.

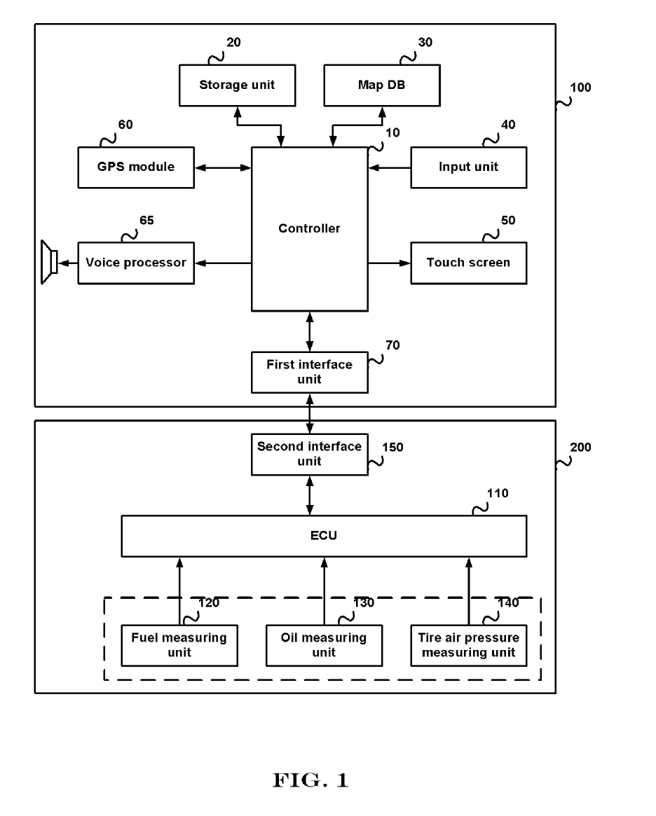

FIG. 1 illustrates a construction of a system for providing vehicle check information using the navigation system according to the present invention.

The inventive system for providing the vehicle check information includes the navigation system 100 and a vehicle control system 200.

The navigation system 100 includes a controller 10, a storage unit 20, a map database (DB) 30, an input unit 40, a touch screen 50, a global positioning system (GPS) module 60, and a first interface unit 70.

The controller 10 controls a general operation of the navigation system. In particular, the controller 10 operates to combine the vehicle check information with the geographical information of the navigation system and provide the combined information to the driver.

The storage unit 20 includes a region for storing a control program, which controls an operation of combining the vehicle check information with the geographical information and an operation of the navigation system; a region for temporarily storing data generated in execution of the control program; and a region for storing data inputted by a user.

The map DB 30 stores map data including scaled map information, a road and a road name mapped to a map by latitude and longitude, and an icon and a name of a building such as the gas station and the service center.

The input unit 40 being a key input device includes a plurality of keys for controlling operations of the navigation system and the inventive system for providing the vehicle check information, and generating data on the keys.

The touch screen 50 is an integration of a display device, such as a liquid crystal display (LCD), and a touch pad, and generates a coordinate value of its portion pressed by the user. The touch screen 50 receives and displays map data on a predetermined area under the control of the controller 10, and displays a button for enabling the navigation system and the inventive vehicle check information providing system and character buttons for inputting characters.

The GPS module 60 receives position information and absolute time information from a plurality of GPS satellites, that is, at least three GPS satellites, and calculates and outputs a current self-position to the controller 10. If so, the controller 10 maps the current position to the map data on a predetermined area inclusive of the current position.

Under the control of the controller 10, the voice processor 65 receives and converts voice data into voice, and outputs the converted voice data as an audible sound through a speaker (SP). In particular, in the present invention, the voice processor 65 receives the voice data for warning short of the fuel, short of the oil, and short of the tire air pressure from the controller 10 and outputs the received voice data as voice, or generates and outputs a beef sound. Accordingly, the storage unit 20 should store and hold the voice data on the short of the fuel, the short of the oil, and the short of the tire air pressure.

The first interface unit 70 performs a data communication between the controller 10 of the navigation system 100 and the vehicle control system 200, based on a controlled area network (CAN) protocol or a local interconnect network (LIN) protocol. The CAN and LIN protocols are protocols for performing the data communication between a vehicle electronic equipment and a vehicle multimedia device.

The vehicle control system 200 includes an electronic control unit (ECU) 110, a vehicle state measuring unit 115, and a second interface unit 150.

The vehicle state measuring unit 115 includes a fuel measuring unit 120, an oil measuring unit 130, and a tire air pressure measuring unit 140.

The fuel measuring unit 120 measures an amount of the fuel, that is, light oil and volatile oil, and outputs the measured fuel amount to the ECU 110.

The oil measuring unit 130 measures an amount of the oil, compares the measured oil amount with a reference oil amount and, when it is determined to be less than the reference oil amount, generates and outputs an oil short signal to the ECU 110. The oil measuring unit 130 can also provide data on the measured oil amount to the ECU 110 as it is.

The tire air pressure measuring unit 140 measures the tire air pressure, compares the measured air pressure with a reference air pressure and, when it is determined to be less than the reference air pressure, outputs an air pressure short signal, or provides data on the measured tire air pressure to the ECU 110 as it is.

The vehicle state measuring unit 115 can further include measuring units such as a battery state detector (not shown) for detecting a battery state in addition to the fuel measuring unit 120, the oil measuring unit 130, and the tire air pressure measuring unit 140.

The second interface unit 150 performs the data communication with the first interface unit 70 by the CAN or LIN protocol.

The ECU 110 controls the general operation of the vehicle electronic equipment and, in particular, receives the fuel amount, the oil short signal or the oil amount, the tire air pressure short signal or the tire air pressure information from the fuel measuring unit 120, the oil measuring unit 130, and the tire air pressure measuring unit 140, and transmits the same to the navigation system 100 through the second interface unit 150. Or, the ECU 110 can also hold the reference oil amount and tire air pressure data, and receive the oil amount and the tire air pressure information from the oil measuring unit 130 and the tire air pressure measuring unit 140, compare the received oil amount and tire air pressure with the reference oil amount and tire air pressure data, and if it is determined as the comparison result to be less than the reference oil amount and tire air pressure data, transmit each of the oil short signal and the tire air pressure short signal to the navigation system 100 through the second interface unit 150.

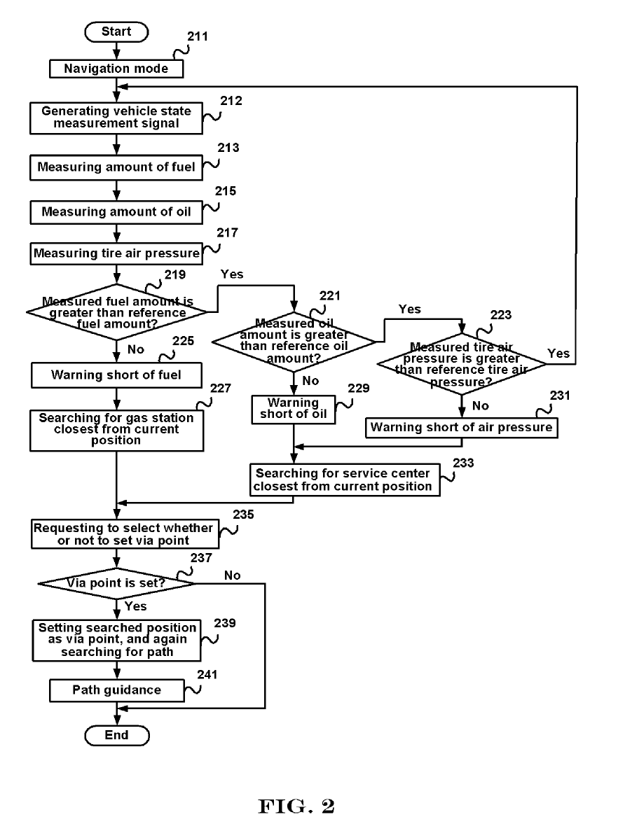

FIG. 2 is a flowchart illustrating a method for providing the vehicle check information using the navigation system according to the present invention, in which the navigation system compares the measured fuel amount, oil amount, and tire air pressure with the reference fuel amount, oil amount, and tire air pressure information, and determines whether or not to perform a guidance service. Hereinafter, an operation of the present invention will be described with reference to FIGS. 1 and 2.

First, upon receipt of a navigation mode command from the input unit 40 or the touch screen 50, in Step 211, the controller 10 sets a navigation mode, receives the current position from the GPS module 60, maps the received current position to the map data, and displays the mapped current position on the touch screen 50. Further, upon receipt of a destination by the input unit 40 or the touch screen 50, the controller 10 performs path guidance to a corresponding position.

In the navigation mode, in Step 212, the controller 10 generates and transmits a vehicle state measurement signal to the vehicle control system 200 through the first interface unit 70, and requests for vehicle state information. After that, upon receipt of the vehicle state measurement signal, the ECU 110 of the vehicle control system 200 receives the fuel amount, the oil amount, and the tire air pressure from the fuel measuring unit 120, the oil measuring unit 130, and the tire air pressure measuring unit 140 in Steps 213 to 217.

Upon receipt of the vehicle station information, in Step 219, the controller 10 determines whether or not the measured fuel amount is less than the reference fuel amount and, if it is determined to be less, warns the short of the fuel amount through the touch screen 50 or the voice processor 65. After that, in Step 227, the controller 10 searches for and selects the gas station closest from the current position using the geographical information, and proceeds with Step 235.

If it is determined to be greater than the reference fuel amount in the Step 219, in Step 221, the controller 10 determines whether or not the measured oil amount is less than the reference oil amount and, if it is determined to be less, warns the short of the oil amount in Step 229 and proceeds with Step 233.

If it is determined to be greater in the Step 221, in Step 223, the controller 10 determines whether or not the measured tire air pressure is less than the reference tire air pressure and, if it is determined to be less, warns the short of the tire air pressure and proceeds with the Step 233.

In the Step 233, the controller 10 searches for and selects the vehicle service center closest from the current position using the geographical information, and proceeds with Step 235.

In the Step 235, the controller 10 displays a message of inquiring whether or not to set the gas station or the service center searched through the Step 227 or 233, as a via point, on the touch screen 50.

After the displaying of the message, in Step 237, the controller 10 determines whether or not the searched gas station or service center is selected as the via point in the input unit 40 or the touch screen 50. Upon receipt of a command of setting the searched gas station or service center as the via point in the Step 237, in Step 239, the controller 10 sets the gas station or service center as the via point and again searches for a path, and performs the path guidance in Step 241.

One of a plurality of the searched gas stations or service centers can be selected in such a manner of selecting the gas station or service center being in a current running direction of and being in proximal to the vehicle.

In an embodiment of the present invention of FIG. 2, the via point is set and the guidance is performed for only one vehicle state, but the same can be also applied for a plurality of vehicle states. For example, when the fuel is deficient and the oil amount or tire air pressure is also deficient, the gas station and the service center being in proximal to the current vehicle position can be also searched and set as the via point.

In searching, the gas station and the service center being on a path, which has the gas station and the service center as the via points and is less deviated from an initial path, can be searched and selected considering a mutual relationship.

FIG. 2 illustrates a case where the navigation system has the reference fuel amount, oil amount, and tire air pressure information. However, as shown in FIG. 1, the vehicle control system 200 can also have the reference fuel amount, oil amount, and tire air pressure information, perform the determination steps of the 219, 221, and 223 of FIG. 2, and transmit the fuel short signal, the oil short signal, and the air pressure short signal to the navigation system 200 and, upon receipt of the signals, the navigation system 100 can search for and select the gas station and the service center using the geographical information, and again search for the path and perform the path guidance.

As described above, the present invention has an advantage of measuring the vehicle state, combining the information on the measured vehicle state with the geographical information, and informing the driver of the combined information, thereby allowing the driver to quickly and calmly cope even when the vehicle state is abnormal.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A system for providing vehicle check information using a navigation system, the system comprising:
a vehicle control system for receiving a predetermined signal, measuring a vehicle state, and outputting information on the measured vehicle state; and
a navigation system for, in a navigation mode, generating and outputting a vehicle state measurement signal to the vehicle control system, receiving and displaying the vehicle state information in response to the vehicle state measurement signal, and, when the vehicle state is abnormal, searching map data for a vehicle check center for checking vehicle abnormality, and guiding to the searched vehicle check center.

2. The system according to claim 1, wherein the vehicle control system comprises:
a vehicle state measuring unit for measuring the vehicle state;
a second interface unit for performing a data communication with the navigation system; and
an electronic control unit for receiving the vehicle state measurement signal through the second interface unit, receiving information on the measured vehicle state from the vehicle state measuring unit, and outputting the received vehicle state information to the navigation system through the second interface unit.

3. The system according to claim 2, wherein the vehicle state measurement unit comprises:
a fuel measuring unit for measuring an amount of a vehicle fuel;
an oil measuring unit for measuring an amount of a vehicle oil; and
a tire air pressure measuring unit for measuring a tire air pressure.

4. A method for providing vehicle check information using a navigation system, in a vehicle check information providing system having a vehicle control system controlling a vehicle electronic equipment, and a navigation system, the method comprising the steps of:
in the navigation system, outputting a vehicle state measurement signal;
in the vehicle control system, receiving the vehicle state measurement signal, and measuring a vehicle state; and
in the navigation system, receiving and displaying information on the vehicle state in response to the vehicle state measurement signal, searching map data for a vehicle checking center capable of checking vehicle abnormality when the vehicle state is abnormal, and again searching for a path having the searched vehicle checking center as a via point, and performing a path guidance.
